(19) United States
(12) Patent Application Publication
(10) Pub. No.: US 2005/0047733 A1
(43) Pub. Date: Mar. 3, 2005

(54) Method and structure for packaging fiber optics device

(76) Inventors: Yu-Wen Hwang, Hsinchu Hsien (TW); Jui-Cheng Kao, Pingtung Hsien (TW); Chih-Wei Huang, Dali City (TW)

Correspondence Address: SUPREME PATENT SERVICES, POST OFFICE BOX 2339, SARATOGA, CA, 95070, US

(21) Appl. No.: 10/829,138

(22) Filed: Apr. 20, 2004

(30) Foreign Application Priority Data
Aug. 27, 2003 (TW) 092123652

(51) Int. Cl. G02B 6/36

(52) U.S. Cl. 385/94

(57) ABSTRACT

A method and structure for packaging fiber optics devices hermetically are provided. The packaging structure comprises a fiber optics sub-assembly that has one or more fibers extending out, a housing cap, and a sleeve. Sealants are permeated into narrow gaps between the fiber optics sub-assembly and other components through a capillary effect to achieve their tight bonding and air-tightness. The packaging method is different from and superior to conventional methods using a soldering process.

### FIELD OF THE INVENTION

The present invention relates to a method and structure for packaging a fiber optics device of fiber communications, and more particularly to a method and structure utilizing a sealant permeated into narrow gaps between components of the fiber optics device through a capillary effect to achieve a hermetical package.

### BACKGROUND OF THE INVENTION

Currently a typical fiber optics device for fiber communications is assembled by first joining optical parts and mechanical parts into sub-assemblies by using sealants. Then a soldering process is conducted to package the sub-assemblies together as a whole into an airtight device. FIG. 1 is a cross-sectional view of a conventional optical add/drop filter packaged by a soldering process. As shown in FIG. 1, various parts are composed together using a sealant into a common port 30 and a transmission port 31 respectively. Then the common port 30 and the transmission port 31 are further packaged together by a soldering process. Within the common port 30, a dual-fiber pigtail 2, a pair of fibers 3a and 3b, a GRIN lens 4, a first glass tube 8a, and a filter 5 are joined together to form a dual-fiber collimator. On the other hand, within the transmission port 31, a GRIN lens 6, a single-fiber pigtail 7, a fiber 3c, and a second glass tube 8b are joined together to form a single-fiber collimator. In a typical operation of the optical add/drop filter, a multi-wavelength light beam shoots into the common port 30 via the fiber 3b. A light with a particular wavelength transmits through the filter 5 and is then focused by the second GRIN lens 6 on an end of the single fiber pigtail 7 adjacent to the GRIN lens 6. The light then emanates out from the fiber 3c. In addition, the filter 5 reflects lights with other wavelengths and they are focused by the first GRIN lens 4 on an end of the dual fiber pigtail 2 adjacent to the GRIN lens 4. The lights then emanate out from the fiber 3a.

The functionality and long-term stability of a fiber optics device such as the optical add/drop filter are highly sensitive to the air-tightness of the device. As shown in FIG. 1, narrow gaps (about 0.005˜0.3 mm) exist between the first glass tube 8a and the dual-fiber pigtail 2, and between the first glass tube 8a and the first GRIN lens 4. The gaps are filled with a sealant through a capillary effect to achieve bonding and air-tightness. The first glass tube 8a is then inserted into a metallic tube 9a and a narrow gap (about 0.005˜0.3 mm) therebetween is also filled with a sealant to achieve tight bonding and air-tightness. Similarly, a sealant is filled into narrow gaps between the second glass tube 8b and the single-fiber pigtail 7, and between the second glass tube 8b and the second GRIN lens 6. The second glass tube 8b is then inserted into a metallic tube 9b and a narrow gap therebetween is also filled with a sealant to achieve hermetical packaging. Then the common port 30 and transmission port 31 are further packaged in a housing tube 11. Before fixing the relative positions of the two ports in the housing tube 11, the two ports are usually shifted and tilted so that the light with the particular wavelength emanating out of the common port 30 and entering into the transmission port 31 should have the maximum intensity (i.e., minimum insertion loss). In other words, the two ports may not be aligned on a same axis. Larger gaps are therefore reserved for position adjustment between the housing tube 11 and the first metallic tube 9a, and between the housing tube 11 and the second metallic tube 9b. A typical procedure is to adjust the two metallic tubes 9a and 9b dynamically until their coupling can achieve the maximum light intensity inside the housing tube 11. Then a solder 12 is used to join and seal the housing tube 11 and the first metallic tube 9a, and the housing tube 11 and the second metallic tube 9b, respectively.

Based on the foregoing description, the package of a typical fiber optics device such as an optical add/drop filter according to a prior art is first to form tightly bonding sub-assemblies by permeating sealants into narrow gaps between various components of the sub-assemblies. Then a soldering process is used to join these sub-assemblies together as a whole into an airtight device. However the soldering process has a number disadvantages. First, during the manufacturing process the heat generated by the soldering process would affect the device components and the light coupling to adjust the relative positions of sub-assemblies becomes difficult, which is not an easy task. The soldering process will also introduce extra stresses into the device, which will be released gradually afterwards and the functionality and long-term stability of the device will therefore be affected. In addition, two additional metallic tubes and two additional glass tubes are required. Moreover, the metallic tubes and the housing tube have to be plated with gold for alloying with the solder tin. These not only increase the dimension of the device, but also increase its material cost.

### SUMMARY OF THE INVENTION

This present invention is directed to obviate the disadvantages of using a soldering process in the package of conventional fiber optics devices. These disadvantages include:
(a) The heat generated by the soldering process during the manufacturing process would affect the device components and the light coupling to adjust the relative positions of sub-assemblies becomes difficult.
(b) The soldering process will introduce extra stresses into the device, which will be released gradually afterwards and the functionality and long-term stability of the device will therefore be affected.
(c) Two additional metallic tubes and two additional glass tubes are required. Moreover, the metallic tubes and the housing tube have to be plated with gold for alloying with the solder tin. These not only increase the dimension of the device, but also increase its material cost.

To obviate the foregoing disadvantages, a packaging method according to the present invention mainly comprises the following steps:
(a) Prepare a fiber optics sub-assembly with a specific function that has one or more fibers extending from its both ends.
(b) Insert a first end of the sub-assembly into a housing cap and fill the narrow gap between the housing cap and the sub-assembly with a sealant to achieve their tight bonding and air-tightness.
(c) Reserve a section (whose length is d1) of the fibers outside a second end of the sub-assembly.
(d) Strip the protective coating of a section of the fibers, starting from a position that has a distance d1 from the second end of the sub-assembly, up to a length d2.
(e) Insert the second end of the sub-assembly into a hole of a sleeve whose aperture only allows the fibers to pass through so that the stripped sections of the fibers are surrounded entirely by the sleeve, and fill the narrow gap between the stripped fibers and the sleeve hole with a sealant to achieve their tight bonding and air-tightness.
(f) Surround the housing cap and the sleeve with a metal housing tube and fill the narrow gaps between the metal housing tube and the housing cap, and between the metal housing tube and the sleeve with a sealant to achieve their tight bonding and air-tightness.

Compared to the prior arts, the present invention basically permeates sealants into the narrow gaps between various device components so that the device can be achieved hermetical packaging. As a soldering process is avoided during light aligning, a fiber optics device with better optical performance, long-term stability, and lower cost can be obtained.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

FIG. 1 is a cross-sectional view of a conventional optical add/drop filter packaged by a soldering process.

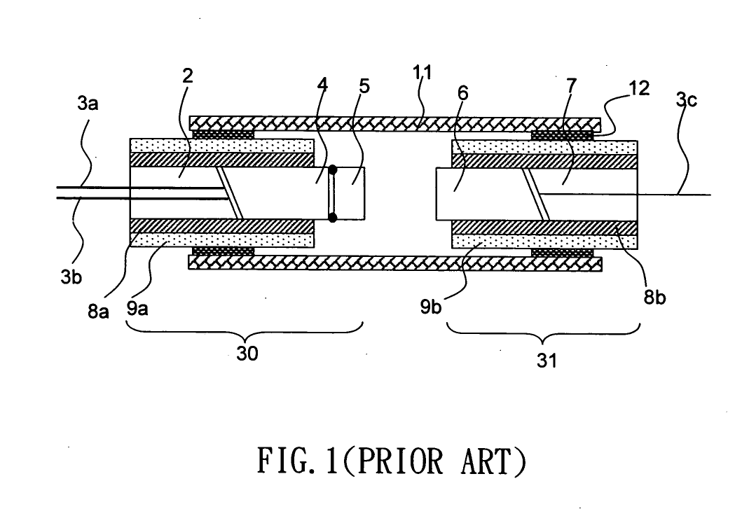

FIG. 2 is a schematic diagram showing various components of a miniature optical add/drop filter.

FIG. 3 is a cross-sectional view of a miniature optical add/drop filter packaged according to a first embodiment of the present invention.

FIG. 4 is a schematic diagram showing, in a miniature optical add/drop filter packaged according to a first embodiment of the present invention, a section of a fiber is reserved behind a fiber optics sub-assembly to buffer the stress resulted from temperature variations.

FIG. 5 shows the relationship of reserved length d1 of the fiber 272 versus thermal expansion coefficient of the metal housing tube 243 under the conditions that the inner section 320 has a length 20 mm, the thermal expansion coefficient of the fiber optics sub-assembly is 7×10⁻⁶/° C., and the thermal expansion coefficient of the fiber is 0.5×10⁻⁶/° C.

FIG. 6 is a cross-sectional view of a multi-port fiber optics device packaged according to a first embodiment of the present invention.

FIG. 7 is a cross-sectional view of a fiber optics assembly with sleeves at its both ends according to a second embodiment of the present invention.

FIG. 8 is a cross-sectional view of a fiber optics device packaged according to a third embodiment of the present invention.

### DETAILED DESCRIPTION OF THE PREFERRED EMBODIMENTS

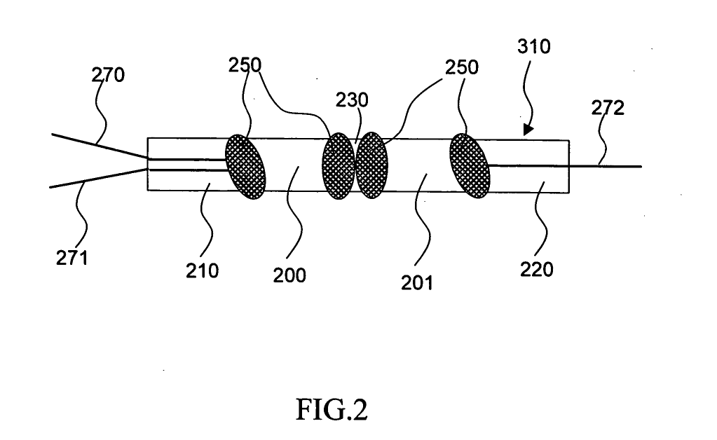

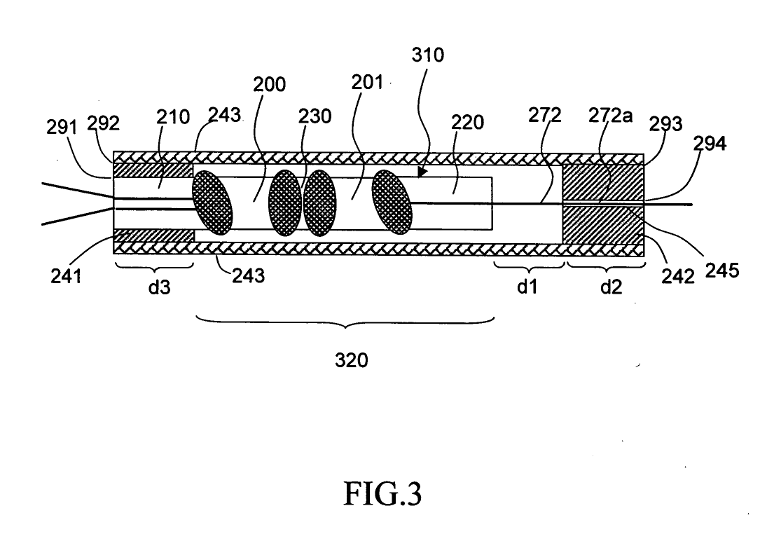

FIG. 2 is a schematic diagram showing various components of a miniature optical add/drop filter 310 comprising a dual-fiber pigtail 210, a first GRIN lens 200, a wavelength-division multiplexing (WDM) filter 230, a second GRIN lens 201, a single-fiber pigtail 220, and fibers 270, 271 and 272. An adhesive 250 is applied at the interfaces between various components for intensification of the interfacings. FIG. 3 is a cross-sectional view of a miniature optical add/drop filter packaged according to the present invention. As shown in FIG. 3, the packaging is conducted as follows. The dual-fiber pigtail 210 is inserted into a housing cap 241 whose length is d3. The housing cap 241 should be made of a material such as metal, glass, or ceramic, that is completely moisture-proof. The housing cap 241 has an appropriate thermal expansion coefficient and is not easy to rust. A narrow gap 291 (about 0.005˜0.3 mm) could exist between the housing cap 241 and the dual-fiber pigtail 210. A sealant such as epoxy resin is then used to permeate into the gap 291 through a capillary effect to achieve tight bonding and air-tightness. The output fiber 272 extends from an output end of the single-fiber pigtail 220 for an appropriate distance. After a distance d1 away from the pigtail 220, a protective coating outside a section of fiber 272a is stripped for a length d2. The protective coating is usually made of acrylic for protecting the fiber inside. However the protective coating is usually too soft to have a strong bonding with the sealant and therefore has to be stripped. Then the fiber 272 is slipped into a hole 245 of a sleeve 242 whose aperture only allows the fiber 272 to pass through. The sleeve 242 is made of a same material as the housing cap 241 and has a length slightly greater than d2 so that the section 272a can be surrounded entirely. A narrow gap 294 (about 0.005˜0.3 mm) would exist between the sleeve 242 and the fiber 272a. A sealant is then used to permeate into the gap 294 to achieve tight bonding, air-tightness, and protection of the exposed fiber 272a. In the end, the housing cap 241 and the sleeve 242 are surrounded with a housing tube 243. A narrow gap 292 (about 0.005˜0.3 mm) would exist between the housing tube 243 and the housing cap 241, and between the housing tube and the sleeve 242. A sealant is then used to permeate into the gap 292 to achieve tight bonding and air-tightness for the whole device. The housing tube 243, besides being completely moisture-proof, not easy to rust, and with appropriate strength, should have a compatible thermal expansion coefficient with those of other components.

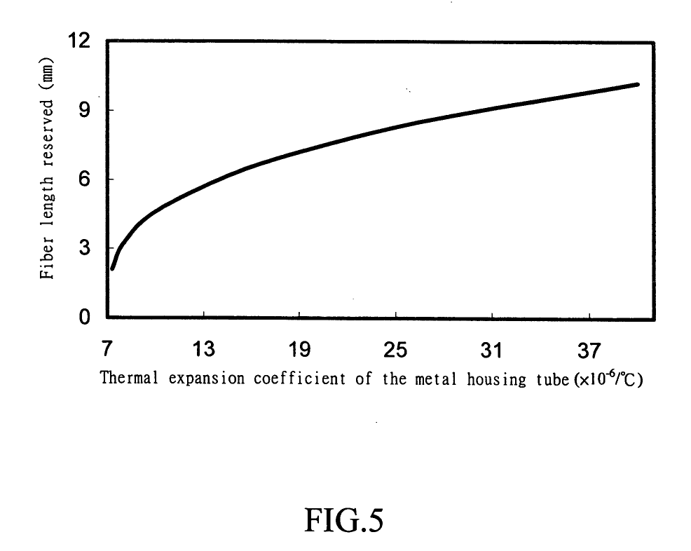

As shown in FIG. 3, the miniature optical add/drop filter 310 is confined inside an inner section 320 of the package by the housing cap 241, the sleeve 242, and the housing tube 243. The materials for the housing cap 241, the sleeve 242, and the housing tube 243 should be chosen to have their thermal expansion coefficients compatible with that of the fiber optics sub-assembly 310 so that, under temperature variations, stresses between them can be reduced. The thermal expansion coefficient of the fiber optics sub-assembly 310 is about 5×10⁻⁶˜9×10⁻⁶/° C., derived from a weighted computation including individual thermal expansion coefficient of every sub-assembly component. A material for the housing tube 243 therefore is better to have its thermal expansion coefficient within the range 5×10⁻⁶˜9×10⁻⁶/° C. In general, the difference in terms of thermal expansion coefficients among the housing tube and the fiber optics sub-assembly is better under 30×10⁻³/° C. and the smaller the better (as shown in FIG. 5).

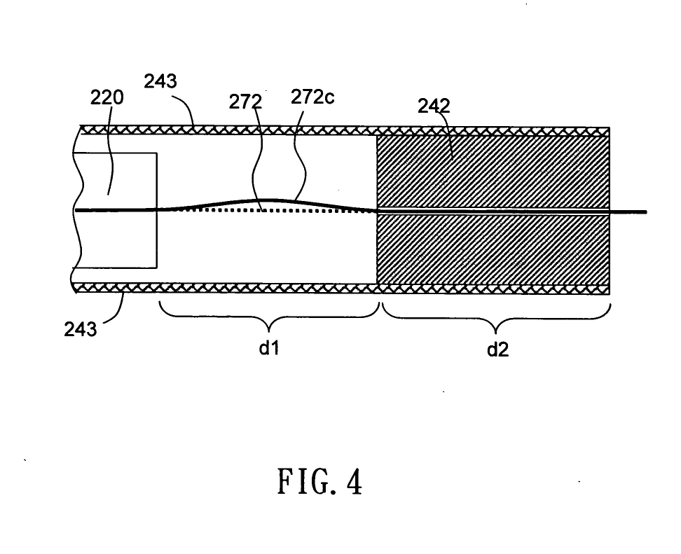

In addition, the section of the fiber 272 whose length is d1 is reserved to buffer the stress resulted from temperature variations. Due to a flexibility of the fiber 272, this section of the fiber 272 will be bended as the fiber 272 is under compression resulted from a temperature dropping from a high temperature to a low temperature and the housing tube 243 contracting more than the fiber optics sub-assembly 310 does. As shown in FIG. 4, the fiber 272 is bended into 272c. If the curvature of 272c has a diameter larger than 40 mm, such a bending will not cause any damage or functional degradation to the fiber optics device. FIG. 5 shows the relationship of the reserved length d1 of the fiber 272 versus the thermal expansion coefficient of the housing tube 243 under the conditions that the inner section 320 has a length 20 mm, the thermal expansion coefficient of the fiber optics sub-assembly 310 is 7×10⁻⁶/° C., and the thermal expansion coefficient of the fiber is 0.5×10⁻⁶/° C. As shown in FIG. 5, the reserved length d1 of the fiber 272 has to be longer as the materials used for the metal housing tube 243 has a thermal expansion coefficient more greater than that of the fiber optics sub-assembly 310.

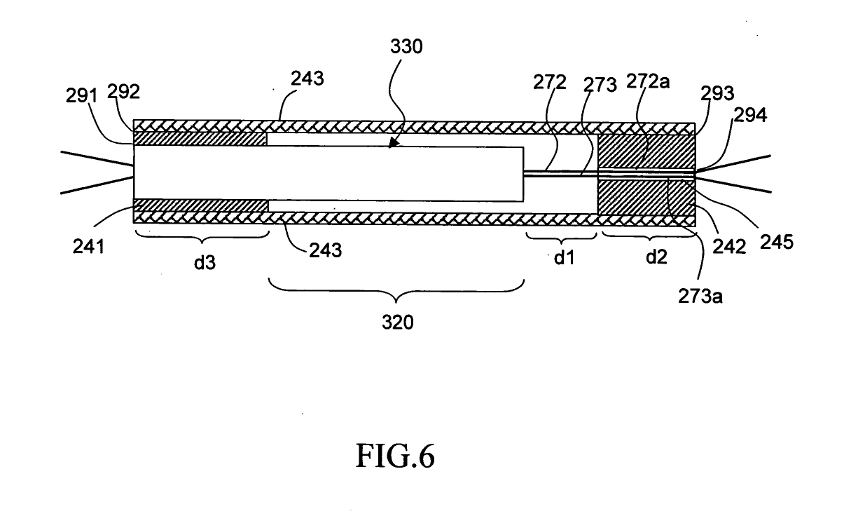

The packaging structure according to the present invention can be applied to the packaging of other fiber optics devices besides the miniature 3-port optical add/drop filter described above. Examples of these fiber optics devices include, but are not limited to, multi-port optical add/drop filters, optical couplers, optical isolators, polarization beam splitters, or other fiber optics sub-assemblies composed of hybrid components. FIG. 6 is a sectional view of a multi-port fiber optics device packaged according to a first embodiment of the present invention. FIG. 6 has a structure almost identical to that of FIG. 3. The differences lie in that a fiber optics sub-assembly 330 has two fibers 272 and 273 extending out of a second end of the sub-assembly 330. Protective coatings of the fiber 272 and 273 are stripped for a length d2 starting from an appropriate distance d1 after the second end of the sub-assembly 330 and therefore expose fiber sections 272a and 273a. A hole 245 at the center of the sleeve 242 has an aperture only big enough to allow fibers 272 and 273 to pass through. The sub-assembly 330 is a fiber optics assembly with a specific function and it can be one of the various product types mentioned above. Based on its product type, the sub-assembly 330 can have one or more fibers extending out of its both ends.

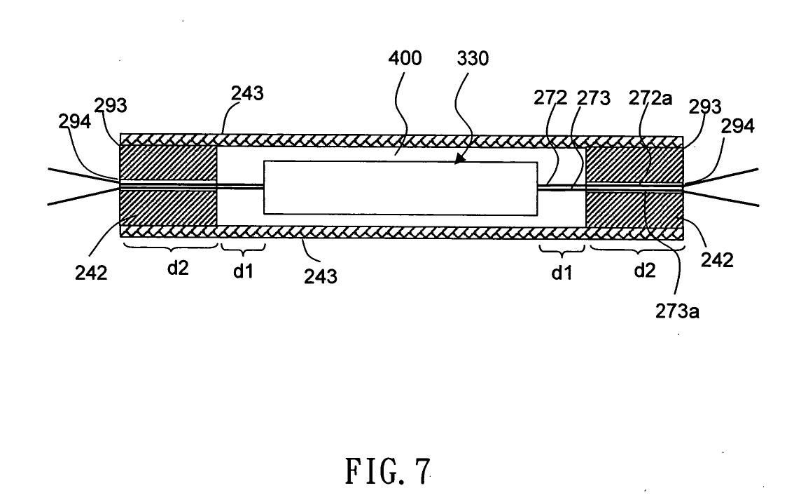

FIG. 7 is a cross-sectional view of a fiber optics sub-assembly 330 packaged with sleeves at its both ends according to a second embodiment of the present invention. The sub-assembly components are joined together as what is shown in FIG. 3. As this structure is more susceptible to external impacts, the package is filled with a softer buffer material 400 such as silicon or rubber.

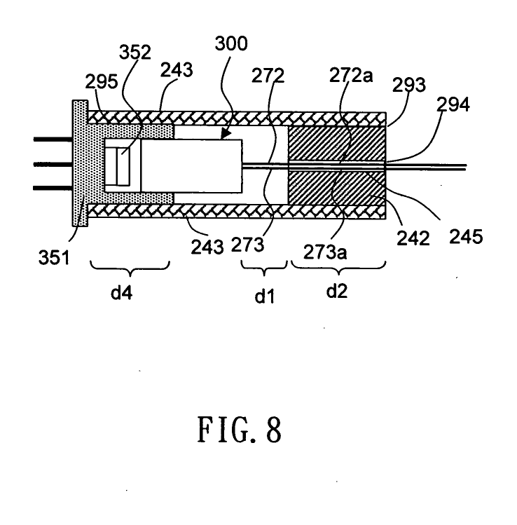

FIG. 8 shows a fiber optics device packaged according to a third embodiment of the present invention. As shown in FIG. 8, a fiber optics sub-assembly 352 comprising VCSEL, receiver, or MEMS is first positioned and fixed to a fiber optics collimator 300 to achieve an optimal light coupling effect. Then the collimator 300 is fixed to a TO-Can 351 and they are slipped into a housing tube 243 together. A narrow gap 295 (about 0.005˜0.3 mm) between the metal housing tube 243 and the TO-Can 351 is then filled with a sealant to achieve tight bonding and air-tightness. The other end of the collimator 300 is packaged in a same way as what is shown in FIG. 6.

Referring to FIGS. 3, 6, 7, and 8, if the lengths of the housing cap 241, the sleeve 242, and the TO-Can 351 (i.e., d3, d2, and d4, respectively) are extended longer, then their contact surfaces with the fiber optics sub-assembly 310, 330, and the metal housing tube 243 will become larger, and an even better tight bonding and air-tightness can be achieved.

Using sealants in the aforementioned assembly methods will contribute to a lower cost. However, if cost is not an issue, some variations can be applied to the assembly methods based on a same packaging structure described above. In FIGS. 3, 6, 7, and 8, tight bonding and air-tightness between the housing tube 243 and the housing cap 241, and between the housing tube 243 and the sleeve 242 can also be achieved using tin soldering or laser welding. The difference between the tin soldering or laser welding here and those used in prior arts lies in that no light coupling is required in the packaging structures according to the present invention as the light coupling is already done between the components of the fiber optics sub-assemblies 310 and 330. Attention therefore only has to be focused on not to bend the fibers severely. In this way, fiber optics devices can be packaged quickly without sacrificing their optical performance. Similarly, tin soldering or glass soldering can also be used between the sleeve 241 and the fibers 272a and 273a for fast packaging.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

1. A method for packaging a fiber optics device comprising the steps of:
(a) preparing a fiber optics sub-assembly with a specific function that has at least a fiber extending from both ends of said fiber optics sub-assembly;
(b) inserting a first end of said sub-assembly into a housing cap and then permeating a sealant into a narrow gap between said housing cap and said sub-assembly to achieve their tight bonding and air-tightness;
(c) reserving a first section of said fiber outside a second end of said sub-assembly;
(d) stripping a protective coating of a second section of said fiber after said first section of said fiber;
(e) inserting said second end of said sub-assembly into a hole of a sleeve whose aperture only allows said fiber to pass through so that said second section of said fiber is surrounded entirely by said sleeve, and then permeating a sealant into a narrow gap between said second section of said fiber and said sleeve hole to achieve their tight bonding and air-tightness; and
(f) surrounding said housing cap and said sleeve with a housing tube and then permeating a sealant into narrow gaps between said housing tube and said housing cap, and between said housing tube and said sleeve to achieve their tight bonding and air-tightness.

2. The method for packaging a fiber optics device according to claim 1, wherein said second section of said fiber has a length shorter than that of said sleeve so that said second section of said fiber is surrounded entirely by said sleeve.

3. The method for packaging a fiber optics device according to claim 1, wherein joins between said housing tube and said housing cap, and between said housing tube and said sleeve are achieved by a tin soldering process.

4. The method for packaging a fiber optics device according to claim 1, wherein joins between said housing tube and said housing cap, and between said housing tube and said sleeve are achieved by a laser welding process.

5. The method for packaging a fiber optics device according to claim 1, wherein said sleeve and said second section of said fiber are joined by a tin soldering process.

6. The method for packaging a fiber optics device according to claim 1, wherein said sleeve and said second section of said fiber are joined by a glass soldering process.

7. The method for packaging a fiber optics device according to claim 1, wherein said sealant is epoxy resin.

8. The method for packaging a fiber optics device according to claim 1, wherein differences in terms of thermal expansion coefficients between said housing tube and the fiber optics sub-assembly are less then 30×10⁻⁶/° C.

9. The method for packaging a fiber optics device according to claim 1, wherein a section of said fiber optics sub-assembly joining said housing cap is made of a material that is completely moisture-proof.

10. The method for packaging a fiber optics device according to claim 1, wherein said housing cap and said sleeve are made of a material that is completely moisture-proof.

11. A packaging structure for a fiber optics device comprising:
a fiber optics sub-assembly having at least a fiber extending from both ends of said fiber optics sub-assembly;
a housing cap surrounding a first end of said fiber optics sub-assembly;
a first section of said fiber extending out of a second end of said fiber optics sub-assembly being reserved, and a second section of said fiber behind said first section of said fiber being stripped of protecting coating;
a sleeve surrounding said fiber extending out of said second end of said fiber optics sub-assembly with a center hole whose aperture allows only said fiber to pass through, and covering said second section of said fiber entirely; and
a housing tube surrounding said housing cap and said sleeve.

12. A packaging structure for a fiber optics device comprising:
a fiber optics sub-assembly having at least a fiber extending from both ends of said fiber optics sub-assembly;
a first section of said fiber extending out of said both ends of said sub-assembly being reserved, and a second section of said fiber behind said first section of said fiber being stripped of protecting coating;
two sleeves surrounding said fiber extending out of said both ends of said sub-assembly respectively, each with a center hole whose aperture allows only said fiber to pass through, and covering said second section of said fiber entirely; and
a housing tube surrounding said sleeves.

13. A packaging structure for a fiber optics device comprising:
a fiber optics sub-assembly having a first end sealed and packaged, and having at least a fiber extending from a second end of said fiber optics sub-assembly;
a first section of said fiber extending out of said second end of said fiber optics sub-assembly being reserved, and a second section of said fiber behind said first section of said fiber being stripped of protecting coating;
a sleeve surrounding said fiber extending out of said second end of said fiber optics sub-assembly with a center hole whose aperture allows only said fiber to pass through, and covering said second section of said fiber entirely; and
a housing tube surrounding said first end of said fiber optics sub-assembly and said sleeve.
